(19) United States
(12) Patent Application Publication
(10) Pub. No.: US 2011/0258200 A1
(43) Pub. Date: Oct. 20, 2011

(54) System and Method for Identifying Persons Having Socially Unacceptable Behavior

(76) Inventor: Amery Drummond, Altamonte Springs, FL (US)

(21) Appl. No.: 12/762,074

(22) Filed: Apr. 16, 2010

(51) Int. Cl. G06F 15/16; G06F 17/30

(52) U.S. Cl. 707/748; 707/802; 707/769; 709/204; 707/E17.014; 707/E17.044

(57) ABSTRACT

A system and method includes hosting a social networking website for identifying persons having socially unacceptable behavior. Users of the social networking site are enabled to anonymously submit documentation regarding a person having socially unacceptable behavior. Strength of the documents is rated based on types of documents. The documentation is stored in a database. Location specific reports regarding persons having socially unacceptable behavior are generated. Access to the documentation is enabled for making informed decisions regarding the person. Transmission of at least part of the documentation between the users, individuals and networks is facilitated. Reporting of at least part of the documentation to government authorities is enabled. Rebuttal of the documentation is enabled. Users are enabled to post responses to submitted documentation for viewing by all users. Communication between the users is enabled. A user is enabled to introduce a friend to multiple users.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to the internet and user generated-social networking. More particularly, the invention relates to collecting user generated and non-user generated data for the purpose of building a database for public use on the internet.

### BACKGROUND OF THE INVENTION

The internet has made it easier for people to communicate, meet, find employment, etc. However, the internet has also provided a certain cover of anonymity. This anonymity has left online social website subscribers with little information on which to base their decisions of whether or not to communicate with other users. Some individuals attempting to connect online may not be good candidates for a job or may not be desirable for a relationship. Some individuals may have acted in criminally, socially or morally unacceptable ways, for example, without limitation, committing crimes, committing domestic violence, participating in adultery, abusing children, stalking, not paying child support, making threats, dealing or using drugs, etc. It is therefore an objective of the present invention to provide more information to individuals communicating online or offline so they have the possibility of making more informed decisions on whether or not to contact, meet, or hire individuals they've met either online, through a third party, or in person.

One prior art solution to this problem asks individuals to submit their personal data including results of sexually transmitted disease testing, prior employment data, criminal records, gender, geographical location, age, physical characteristics, lifestyle choices, educational level, income level, etc. to a partner website, directly to a main website, or at a physical satellite location or affiliate where the information is then checked for its truthfulness. At this point, a color labeling system is used to label the information as being either true or false. The profiled individual provides authorization to the service to verify information, including medical test results and records. A user of this service is able to use this information to make informed decisions about an individual before actually meeting them in real life.

In another solution individuals are able to exchange URL information when they meet, for example, without limitation, outside of a nightclub. The individuals are then able to use the URL information to see the results of the profiled person's verification process. The exchange of URL's may take place online or offline. This URL information may also be provided to places of employment when looking for a job. In one version of this solution, the verification site receives payment for their services.

Others have addressed this problem by asking profiled subscribers/applicants to provide specific information about themselves either to a third party for verification or directly to their databases. Another method that has been used is the sale of criminal records in an attempt to help employers or individuals make informed decisions.

The idea of gathering and storing information is common to many different procedures, not just for the purpose of criminal records, employment data, or medical records. Employers have used a similar system where an applicant presents at a human resource department and fills out an application for employment, and the information under the previous employers, references sections, phone numbers, and other contact information is provided for verification. The information may not be collected and kept in a single location or with a third party in all cases; however, the process of collecting and verifying information is and has been in use.

The prior art is limited in that it relies on the person being profiled to provide 100% truthful information. Unless there is a legal mandate to submit this sort of private material (e.g., medical records, medical tests results, criminal history, etc.), applicants may be reluctant to use these services or to provide accurate information. Another disadvantage of the prior art is that it does not make use of a social networking format, which could net much more information without the need to ask the person in question to submit data or to agree to a verification process. The prior art may also use information from references obtained by the person in question. These references can be questionable in that they may be biased toward the person being profiled as this person would not likely provide references that would provide unfavorable information about the person in question.

Current solutions that rely on criminal records are limited in that they do not address the problem of unreported (to law enforcement) but known (by victims, witnesses) crimes, which would not turn up in a criminal record check, and in the event that there is no criminal record, those searching would have very little information to go on. These solutions also do not have a method of collecting data on other socially unacceptable behaviors (e.g., drug use, chronic lying, rage, racism, elder abuse, child abuse, cheating, adultery, alcohol abuse, harassment, sexual harassment, sexually aggressive behavior, threats, rape, domestic violence in all it's forms (social, economic control, put downs, yelling), etc.) that are not in and of themselves crimes, yet are undesirable to employers and others that may be looking to gather information for the purpose of making informed decisions in starting any sort of relationship, whether they be on or offline.

In view of the foregoing, there is a need for improved techniques for providing a method for collecting accurate information about people attempting to connect with others or find employment, whether it be online or offline, that makes use of online social networking and does not rely solely on the truthfulness of the persons in question. (i.e. people that users are searching for information on).

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary social networking system for sharing information concerning other individuals, in accordance with an embodiment of the present invention.

FIG. 2 illustrates an exemplary social networking system for sharing information concerning other individuals, in accordance with an embodiment of the present invention.

FIG. 3 illustrates an exemplary social networking system for sharing information concerning other individuals, in accordance with an embodiment of the present invention; and,

FIG. 4 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a system and method for identifying persons having socially unacceptable behavior is presented.

In one embodiment a system includes means for hosting a social networking site, means for enabling users of the social networking site to submit documentation regarding a person having socially unacceptable behavior, means for storing the documentation, means for facilitating transmission of at least part of the documentation between the users, individuals and networks and means for enabling communication between the users.

In another embodiment a method executed by one or more processors includes steps for hosting a social networking site, steps for enabling users of the social networking site to submit documentation regarding a person having socially unacceptable behavior, steps for storing the documentation, steps for facilitating transmission of at least part of the documentation between the users, individuals and networks, and steps for enabling communication between the users.

In another embodiment a method executed by one or more processors includes the steps of hosting a social networking website for identifying persons having socially unacceptable behavior. Users of the social networking site are enabled to anonymously submit documentation regarding a person having socially unacceptable behavior. Strength of the documents is rated based on types of documents. The documentation is stored in a database. Location specific reports regarding persons having socially unacceptable behavior are generated. Access to the documentation is enabled for making informed decisions regarding the person. Transmission of at least part of the documentation between the users, individuals and networks is facilitated. Reporting of at least part of the documentation to government authorities is enabled. Rebuttal of the documentation is enabled. Users are enabled to post responses to submitted documentation for viewing by all users. Communication between the users is enabled. A user is enabled to introduce a friend to multiple users.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Preferred embodiments of the present invention provide an online community where users can post information, network with other users, and upload pertinent data, including, but not limited to, official and unofficial documents, pictures, and video to a website database in an attempt to share information with other users of the website in regards to criminal, non-criminal, and socially and morally unacceptable behavior by certain individuals. Preferred embodiments of the present invention provide awareness so that people can make informed decisions in regards to whom they date, do business with, employ, and otherwise interact with both online and offline.

Preferred embodiments use social networking to identify people who have committed crimes, domestic violence in all of its forms (i.e., put downs, shouting, social and economic control), adultery, cheating, animal abuse, and all other forms of socially, or morally, unacceptable behavior, including, but not limited to, those behaviors that can lead up to domestic violence or worse, including death. Preferred embodiments also provide anonymous reporting to the police, child care and social services concerning elder abuse, violence, rage, stalking, not paying child support, sexual aggression, making threats, philandering, dealing drugs, using drugs, alcoholism, sexual harassment, electronic harassment and abuse, etc. Preferred embodiment may help identify many types of objectionable people such as, but not limited to, chronic liars, rapists (statutory, convicted or not), cheaters, adulterers, racists, pedophiles, male chauvinists, feminist Nazis, etc. and many forms of destructive personalities or behavioral disorders, whether they be diagnosed or undiagnosed.

Preferred embodiments enable subscribers to scan and upload evidence to strengthen their disclosures such as, but not limited to, pictures of injuries, property damage, hospital records, police reports, insurance claims reports, audio messages such as, but not limited to, threatening voice mails (mp3, way, or any other computer file format), or any other scanned document or video. Subscribers of preferred embodiments are able to search these documents with multiple search fields. In preferred embodiments, non-subscribers of the social networking website are only allowed to search the database, obtaining only limited bits of information, while subscribers have full privileges including, but not limited to, networking, video chat, access to all reports and documents, etc. In preferred embodiments subscribers are able to interact with each other, creating networks in which they can share posts, stories, accounts, eyewitness testimony, etc. Through these means, subscribers are generally able to avoid undesirable individuals and situations that could occur from being in that person's company. In preferred embodiments, subscribers are also be able to post regional wide or national ads such as, but not limited to: “Does anyone have any information on John Doe or Jane Doe?” where other subscriber receive messages on this and are able to provide information or introduce the subscriber asking the question to someone who might or does have information through an introduction method. Companies seeking employees or researching current employees may also refer to databases in preferred embodiments. Law enforcement may also use preferred embodiments of the present invention to find clues to help solve cases or to actually find profiled persons.

Preferred embodiments of the present invention can help prevent domestic violence or death from domestic violence through awareness and preparedness. Preferred embodiments can also help solve the problem of people cheating on others and marital infidelity by helping to identify those that move from relationship to relationship and cheat with impunity. Preferred embodiments can help keep people accountable for their unsavory behavior and can help decrease societal occurrences of disagreeable behavior; people may think twice before they do something wrong or hurtful to others. Preferred embodiments can help solve the problem of child and elder abuse by encouraging the reporting of such abuses and those that are responsible. Preferred embodiments can help stop stalkers by exposing their shameful practice. Preferred embodiments can help take the shame out of reporting embarrassing crimes to authorities by sending messages directly to the authorities through an online reporting system. Preferred embodiments can help prevent sexually aggressive behavior by exposing past occurrences, causing shame and causing the person in question to reassess their actions. Preferred embodiments can help fill the information void between ex girlfriend/boyfriend and current girlfriend/boyfriend by providing a means in which to contact each other through the website using video chat, audio chat, or email. This enables ex dating partners to be in direct contact with current dating partners to provide references or warnings, thus allowing the person that is seeking information to be better informed while making their decisions. Preferred embodiments can help fill in the blanks on an individual's dating or social resume that may have otherwise remained void.

A desired characteristic of preferred embodiments of the present invention is to create change in society by introducing a more thorough system of checks and balances that place a part of the moral burden on society in asking them to report everything that they see and hear in order to promote awareness and ultimately prevention of certain crimes and the untimely loss of life. Preferred embodiments enable society to take a more direct role in the responsibility of others' safety and the betterment of society. They can do so by actively reporting what they know, and in turn they can better the world around them and hopefully save lives. Another desired characteristic of preferred embodiments of the present invention is that would-be criminals and would-be doers of heinous or disagreeable acts as listed in the foregoing may change their course for fear of being found out and a fear of being excluded from the work place and ultimately society (i.e., ostracism). Preferred embodiments may cause these individuals to know that others are holding them accountable for their actions and that it may not be as easy to get away with wrongdoing as it was previously. Yet another desired characteristic of preferred embodiments is that subscriber may feel more assured as they make decisions on whether or not to meet people for business, romantic, or any other type of relationship. Yet another desired characteristic of preferred embodiments of the present invention is that they provide law enforcement with a valuable resource that they can use to find people that have committed crimes, continue to commit crimes, and are possible suspects, or persons of interest (witnesses) in crimes that have been committed, in order to gain valuable leads in a case, and to ultimately hold criminals accountable

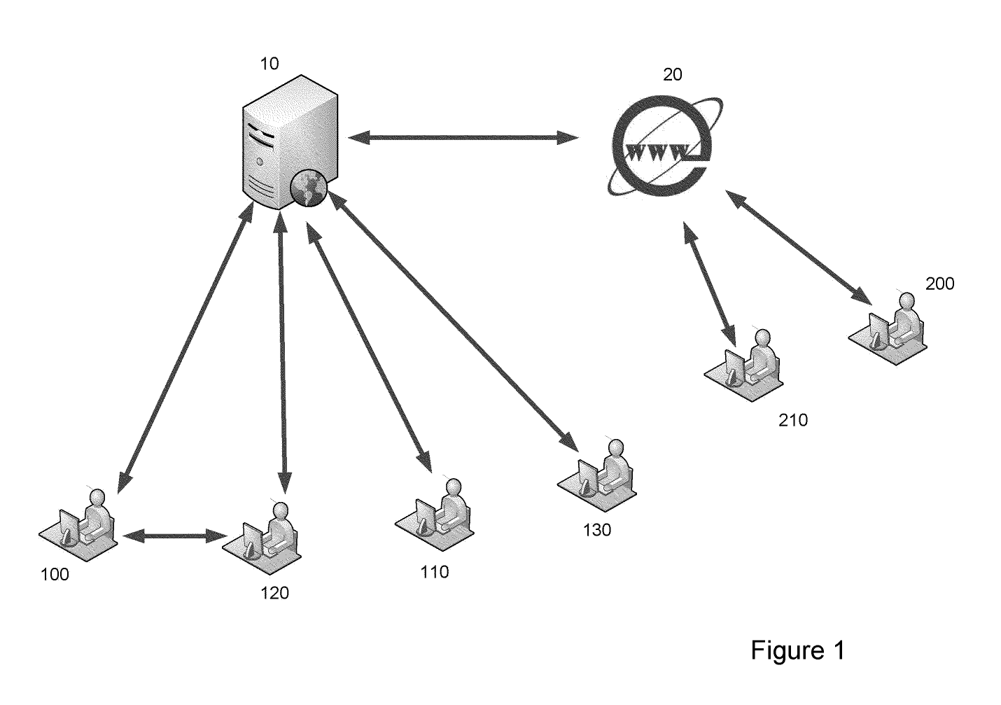

FIG. 1 illustrates an exemplary social networking system for sharing information concerning other individuals, in accordance with an embodiment of the present invention. In the present embodiment, a social networking website 10 is used to store data generated by users 100, 110, 120, and 130 and to make the communication between users 100, 110, 120, and 130 easier through the use of tools such as, but not limited to, social networking, email, notes, public profile comments, instant messaging, blogging, audio messages, VOIP, voice mail, video chat, video viewing, video messaging, public bulletin boards, forums, adding friends, adding secret contacts, etc. Users 100, 110, 120, and 130 may be people, robots or computers who are using computers or those that are using mobile devices that are designed for internet use, more specifically social networking, such as, but not limited to, cellular phones or other mobile devices designed with internet or WiFi connectivity. The present embodiment allows for a third party social networking website 20 and subscribers 200 and 210 of third party website 20 to have access to the database and server of social networking website 10. Third party subscribers 200 and 210 may use computers or mobile devices with internet connectivity to connect to website 10. Third party website 20 may be a database or a search engine such as, but not limited to, Google, Yahoo, Facebook, Myspace, Linkedin, etc. Third party website 20 has access to the database of website 10 through a signed agreement between the two websites' management. Users 100, 110, 120, 130, 200, and 210 are able to search pictures, videos, hospital records, and police reports by using search parameters of the database including, without limitation, city, state, name, date, year, etc. The present embodiment also gives users 100, 120, the choice as to whether they want to email the information to themselves or to forward it to multiple users and to other email providers, including, but not limited to, mobile providers not affiliated with social networking website 10. User 100 represents a subscriber to website 10 that is using a computer (i.e., non-mobile device) that is searching directly through website 10 and not through third party site 20. User 110 is a non-subscriber that is using a computer (i.e., non-mobile device) and is searching directly from website 10. User 120 is a mobile subscriber that is searching directly through website 10, and user 130 is a mobile non-subscriber that is searching directly through website 10. User 200 may be a non-subscriber or a subscriber that is searching using third party website 20, and user 210 may be a mobile device non-subscriber or subscriber that is searching through third party website 20. In the present embodiment, website 10 is open source and enables programmers to build and add applications such as, but not limited to, games, applications and tools.

In the present embodiment, users 100 and 120 of social networking website 10 are subscribers and only they are able to communicate with other subscribers. Only subscribers, users 100 and 120, are able to upload and download information from social networking website 10. User 120, who is a subscriber and who uses a mobile device such as, but not limited to, a cellular phone with internet capability, is able to upload information from the mobile device. Referring to FIG. 1, both user 120 and user 100 are able to communicate with each other through various means including, but not limited to, email, notes, public profile comments, instant messaging, blogging, audio messages, VOIP, voice mail, video chat, video viewing, video messaging, public bulletin boards, forums, etc. Subscribers 100, and 120 are able to communicate with each other instantaneously within the website (10)

Referring to FIG. 1, users 100, 110, 120, and 130 are shown transmitting and receiving information to and from the database of social networking website 10. All transmissions go through the database. Subscribers/Users 100 and 120 cannot independently share information with each other without the database of the social networking website 10. Subscribers/Users 100, and 120 may receive occasional emails containing links to reports, blogs, vlogs, and any information that is relevant. Non-subscribers (110, 130) cannot communicate with each other through the invention's website 10.

The database of social networking website 10 sends information to and receives information from various designated third party websites 20 including, without limitation, internet search engines and databases such as, but not limited to, Google, Yahoo, MSN, and other social networking websites such as, but not limited to, Facebook, Myspace, Linkedin, etc. Third party users 200 and 210 or subscribers who are not logged into their accounts through the database of social networking website 10 are able to gain limited access through third party websites 20. Users 200 and 210 or subscribers who are not logged in cannot communicate with each other and are limited to searches for information. Users 110, 130, 200 and 210 are not allowed to communicate with members unless they subscribe or log in (users 200, 210) to the inventions website 10.

In the present embodiment, subscribing users 100 and 120 may post information to the website 10, whether or not there has been a criminal conviction, in an attempt to prevent undesirable outcomes by having information to urge others to avoid contact with that person rather than meeting the person in question and being sorry that they did. Subscribing users 100 and 120 are also able to report anonymously to law enforcement, child social services and any other authority by way of a secure email server. Registered subscribing users 100 and 120 may also be able to post audio responses to reports of any medium such as, but not limited to, video, photo, etc. The present embodiment offers an advantage over the prior art in that it does not rely solely on criminal prosecutions but rather uses the weight of evidence from first hand encounters of individuals to provide information that could be useful in helping to avoid an attack or an undesirable person. Many times, individuals fail to report crimes for fear of wanting to deal with law enforcement. However, using the present embodiment, they can help others so that others will not have to go through the terrible ordeal they did. The present embodiment also picks up on the warning signs before they manifest into crimes and focuses on prevention. The present embodiment also uses the psychological tool of deterrence to help prevent even more crimes or undesirable actions. The fear of societal ostracism and retribution is one of the catalysts that drive the present embodiment.

In an attempt to stave off false claims posted to website 10, website 10 includes a strength indicator based on the types of documents users upload to website 10. For example, without limitation, a report may be deemed as strong if it includes a police incident report, phone records, and a hospital record in conjunction with pictures, video and corroborating eyewitness testimony of the accounts. Furthermore, individuals that have had reports posted to website 10 about them are able to rebut the claims made in the reports. Accused individuals are also able to produce and upload their own evidence in the form of police incident reports, hospital bills, phone records, video, etc. in order to strengthen the rebuttal in an attempt to defend against allegations. They may search as non-subscribers, subscribe, and they may also post reports and perform every function that website 10 offers to both subscribers 100 and 120 and non-subscribers 110 and 130. These individuals 200, 210 may also search from third party websites 20.

The present embodiment enables subscribers 100 and 120 to have the option to add friends, start a network, communicate through blogs, vlogs, email, post, and upload material and all other forms of communication on website 10 anonymously. Under the user-generated posts, subscribers 100 and 120 are able to comment in a blog format, post video blogs, audio blogs, post pictures, etc. Subscribers 100 and 120 may also automatically have information sent to them on a specified person via email, to a mobile device or both as it is posted. Non-subscribers 110, 130 and third party users 200 and 210 are only allowed to search the database of website 10 and view and listen to all posted information, files such as, but not limited to, videos, audio files, reports, claims, etc.

In order to create a social networking website according to the present embodiment, a creator should first register an appropriate domain name. A name that reflects the nature of the website is preferred. The creator should then find a company that hosts social networking websites and will allow the creator to use his own registered domain name without any tag names from the hosting company on the end of the registered domain name. If the creator prefers not to use a company that creates and hosts template social networking sites, he may instead hire a computer programmer or a company to build a website from scratch or build the website himself. In the present embodiment, the program is preferably kept open source to enable programmers not directly related to the management of the website to be able to make games and other applications that could be useful to the users of the website. The website should have all the necessary tools provided to accomplish all the tasks that the creator wants to make available to the users. For the present embodiment, a video chat, audio uploading capability, video streaming and upload capability, a designated area where users can post reports, a dedicated area where users can upload files, reports, pictures, text messages, voice mail from cellular phones, home phones, voice chat, a picture upload function, a unique introduction system, and an anonymous feature are all put in place in order to generally ensure the comfort and ease of allowing users to communicate with those within their network. All of these tools work together to make the process as smooth as possible. The company that maintains the social networking website is typically charged with doing this. The unique online introduction system enables users to introduce multiple people to a friend simultaneously with a simple click and drag feature.

In order to enable outside users to search the website database through third party websites such as, but not limited to, Google and Yahoo, the proper agreements must be made between the website management and the management of the third party sites. The social networking site is user generated so users should already understand the concept of creating a profile and posting information. Since there are various new aspects to the present embodiment, detailed instructions should be provided to help users understand why and how they are to complete a function and what the expected outcome of that function is. The users are able to add friends and create regional, statewide, and countrywide networks where they can share information to help promote awareness and ultimately the prevention of domestic violence and the union with undesirable or potentially dangerous people. Users will be able to send out invitations for their friends to join their networks where they are able to benefit from the knowledge and power of the network.

The website is user generated so users may need to be taught how and why they are posting this specific information. Users should understand that the website is for the good of society. The information that is being shared can help prevent the injury or even death of someone else and will in the end better society. The website may also be informative in that it may show people statistics and pictures of victims of domestic violence. This serves to educate people of the reality of the situation that the website seeks to help prevent. Users are urged to post material to help protect others. Families of domestic violence victims may be encouraged to post online memorials using the website. The website may make agreements with major internet search engine companies such as, but not limited to, Google, Yahoo and MSN to have the website data listed in their search results. This gives internet users world wide more access to the website and gives the search engine companies more users and opportunity for advertisers.

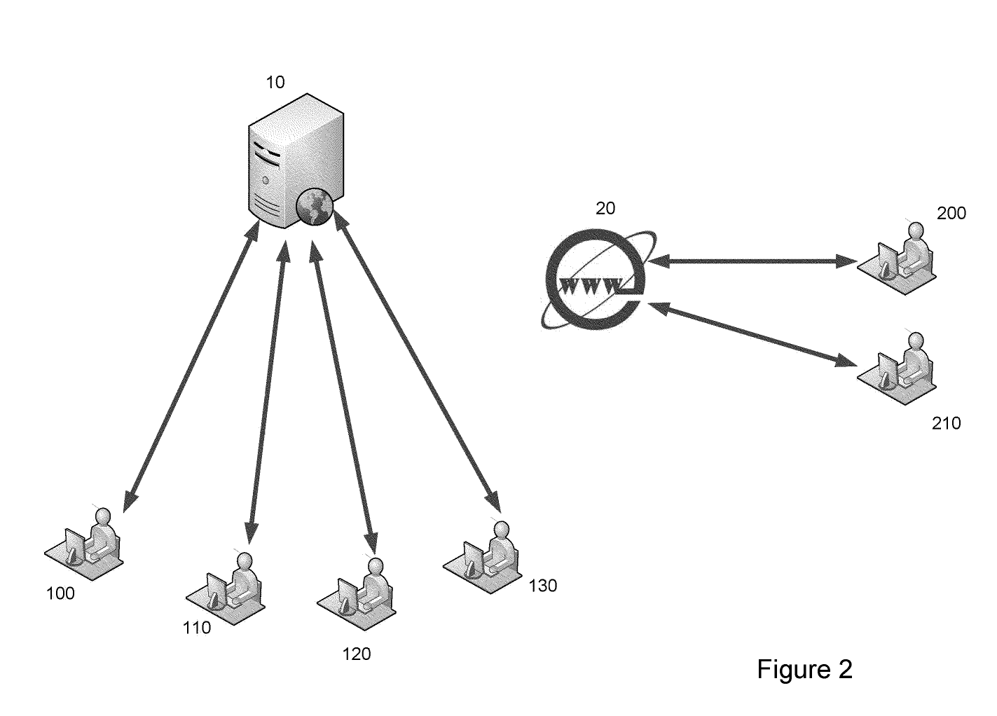

FIG. 2 illustrates an exemplary social networking system for sharing information concerning other individuals, in accordance with an embodiment of the present invention. In the present embodiment, users 100, 110, 120 and 130, who are subscribers and non-subscribers at computers or on mobile devices, can visit the database of a website 10 to search for information. However, these users are not able to communicate with each other through website 10 as in the embodiment previously described. Users 200 and 210, who may be subscribers or and non-subscribers on mobile devices or on computers, can access the database of website 10 to search from designated third party sites 20 including, but not limited to, search engines, websites, and databases. User 100 represents a subscribed member that searches directly through website 10 using a computer (i.e., non-mobile device). User 110 represents a non-subscribed user that performs searches directly through website 10 using a computer (i.e., non-mobile device). User 120 represents a subscribed mobile device user that searches directly through website 10. User 130 represents a non-subscribed mobile device user that searches directly through website 10. User 200 represents a subscriber or a non-subscriber that is using a computer (i.e., non-mobile device) that searches website 10 through third party website 20. User 210 represents a non-subscriber that searches website 10 through third party website 20. Subscribing users 100 and 120 on computers and on mobile devices are able to search for information on people, and post information such as, but not limited to, pictures and blogs, upload medical and hospital reports, insurance reports, claims, documents, etc. Non-subscribing users 110, 130, 200, and 210 who search directly through website 10 and through third party sites 20 are not be able to post any information. Their activities are limited to searches. These users are limited to certain types of searches and information and do not have full access to information, only preliminary search results and information. This is to encourage more users to register with website 10.

In order to create a social networking website according to the present embodiment, a creator first creates a website that can support the use of streaming video, audio recording and playback, pictures and a website that gives users the ability to download anything from the site. Then the creator makes agreements with search engines such as, but not limited to, Google, Yahoo, and MSN to index the information contained in the database of the website in their searches results. This enables users who are not logged into the website to conduct quick searches, even though these searches may not yield conclusive information. In order to more reliably get conclusive search results, the user should register and search through the website.

The website is user generated so users may need to be taught how and why they are posting specific information. Users need to understand that the website is for the good of all. The information that is being shared can help prevent the injury, or even death, of someone else and may better society. The website is informative in that it shows people statistics and pictures of victims of domestic violence. This serves to educate of the reality of the situation that the website seeks to help prevent. Users are urged to post material to help protect others.

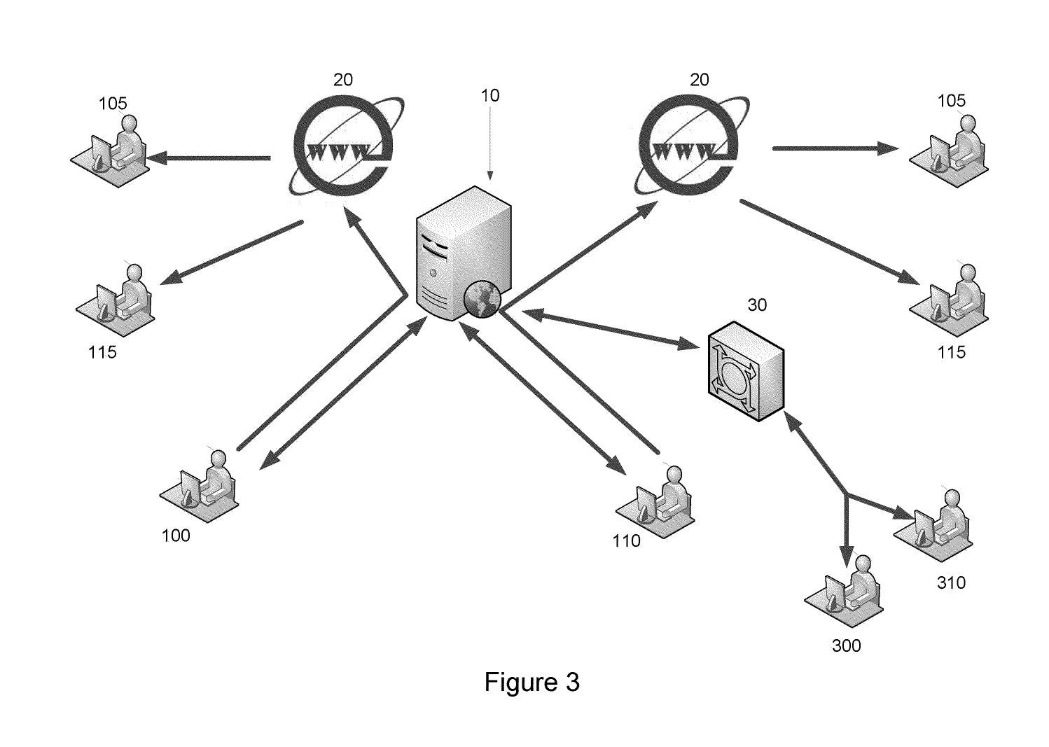

FIG. 3 illustrates an exemplary social networking system for sharing information concerning other individuals, in accordance with an embodiment of the present invention. In the present embodiment, a user 100 represents a computer user that is able to post and view all information as well as forward invitations and limited reports to outside persons 105 and 115 through their email providers 205. A user 120 represents a mobile device user that is able to post and view all information as well as forward invitations and limited reports to outside persons 105 and 115 through their email providers 205. A user 300 represents a caller from a landline telephone that is either a registered subscriber or a non-registered subscriber with a social networking website 10. User 300 is able to post information to website 10 via an operator 30, which may be a human operator or an automated system that enables them to record and save information. User 300 can also receive information through operator 30. A user 310 represents a caller from a cellular phone or mobile device that is either a registered subscriber or a non-registered subscriber with website 10. User 310 is able to post information to website 10 via operator 30. User 310 can also receive information through operator 30. Users 105 represent people that receive solicited or unsolicited emails containing limited amounts of information from registered users 100 and 120 of website 10. Users 115 represent registered users of website 10 that receive solicited or unsolicited emails from other registered users 100 and 120 of website 10. Users 115 are able to click on a link in the email and view all of the information once the system is able to verify their membership.

In the present embodiment website 10 is user generated. Only certain users, registered subscribers 100 and 120, are able to post information to website 10 for others to view. Both mobile device users 120 and computer users 100 are able to post information and view information from website 10. Users 300 and 310 who call operator 30 from either a landline or a mobile device are able to receive information from operator 30 at a toll cost. Users 300 and 310 are also be able to report to operator 30, and this information is entered into website 10 as evidence to be viewed or listened to online through the database of website 10. Users 300 and 310 do not have to be subscribers of website 10.

After a member completes a search, the search results are listed in numerical order of relevancy. Registered users 100 and 120 are able to click on a search result and view pictures of the victim, the accused, and pictures of anything else relevant that has been posted to website 10 such as, but not limited to, injuries and property damage, listen to audio, watch video, and view documents such as, but not limited to, police reports, insurance claims, hospital records, etc. Registered users 100 and 120 are also able to rebut claims that have been made against them or anybody else by computer, mobile device, landline or cellular phone. They first have to enter the website and look for the report someone has filed regarding them and then follow the instructions to post a rebuttal. Non-registered users 105 have access to limited information and are prompted with the option to register to view all of the information on the database of website 10. Registered users 100 and 120 may forward search result information to outside email accounts; however the non-registered recipients 105 are not able to view all of the information. Registered users 100 and 120 may also forward information to other registered users 115 who are then able to click a link that asks them to verify their membership. Then they are taken to the website 10 where they are provided with the information.

In order to create a social networking website according to the present embodiment, a creator should first register a domain name and then find a company that can host a website. The creator may hire someone to design the website or may design it himself. The first page of the website should have an area for members to log in and a section for new users to subscribe. The first page should also have a search field where anyone can search; however, only registered members have access to all information and are able to post information for the public to view.

In order to set up a hotline feature of a social networking website according to the present embodiment, the creator must first buy or reserve some business phone numbers and then design, program or buy an automated telephone system that can record data and ready it for transcriptionists who later transform the data into documents to be posted on the website or enter the data into the database of the website to be viewed by users. The creator may also use a live operator that doubles as a transcriptionist that enters the information into the database of the website.

The website may also sell 7 space to advertisers to cover the expenses of maintaining the website. The website should be made so that users can post a variety of data including, but not limited to, picture files such as, but not limited to, jpg, jpeg, and tiff, and users should be able to upload any type of video or audio file to the website. The website should have the proper media players that can support and play these types of files. Users are also able to type up reports within the website and then submit them. The website database must have a search function built in so that users can search by name, city, country, height, race, and other characteristics. The website is informative in that it shows people statistics and pictures of victims of domestic violence. This serves to educate others of the reality of the situation that the website seeks to help prevent. Users are urged to post material to help protect others from the same abuses that they encountered and that they want to help others avoid.

Some embodiments of the present invention may use an already established private email database, create a database, or achieve access to a database in which demographic data is explored and targeted e-mails including, but not limited to, video links, video, pictures, picture links, audio links, audio files, written documents, research material, user generated blogs, vlogs, audio blogs, etc. are sent to certain people within a demographic that may benefit from the information. People may then visit the website in order to obtain access to the information, therefore driving up website traffic and access to advertisement revenue.

Some embodiments of the present invention also use a public blog, vlog, audio blog format in which users can post questions in a public forum about a specific person or persons in order to learn information in regards to arrests, past domestic abuse allegations, either previously disclosed or undisclosed, information into drug or alcohol abuse, or any other unsavory allegations that have been deemed socially unacceptable. This information is then aggregated and used for future user searches.

Some embodiments of the present invention may use second-life applications to facilitate the gathering of information from different sources (e.g., virtual places and businesses) within the second-life world application. Users are able to access the user-generated database via second-life applications. These embodiments offer information on a simple website format (i.e., non-social networking style) that is searchable by name, city, picture, video, or audio file and is open to the public for free without registration.

Some embodiments may enable users to email requests to a company for information or reports on individuals, and the company in turn emails the results or reports to the users. The company by request can post information in publications on a website, whether it is a social networking website or a standard webpage.

Some embodiments may enable users to call an automated hotline using a cell phone, a landline, or a VOIP phone to conduct searches and receive results via text, email, or audio. Users are then able to listen to prerecorded messages and communicate with other users anonymously via special codes that allow them to contact other members.

Some embodiments give users the capability to print, email, and verify police reports and hospital records for those users who may have doubts as to the veracity of another user's claims.

Some embodiments provide a service where people receive data in their inbox about offenders in their area and any other areas the user chooses.

Some embodiments give users the ability to meet other members in person for the purpose of swapping information.

Some embodiments of the present invention offer up to date sex offender convictions, locations, and news styled feeds on domestic violence, adultery, and user generated information on new perpetrators in a specified area.

Some embodiments of the present invention give users the ability to play games in which they try to decide, using pictures of perpetrators that are posted by users, which person has committed acts of domestic violence, has demonstrated sexually aggressive behavior, has a foul temper, is or has been a drug dealer, and other socially unacceptable behaviors. These embodiments then allow users to forward the game on to their network. This is to seek to educate users through the usage of games and posting scholarly journals articles related to the website. Users are also able to forward game results, attached articles, blogs, vlogs articles, and journals to other users or non-users in an attempt to spread awareness and drive website traffic.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

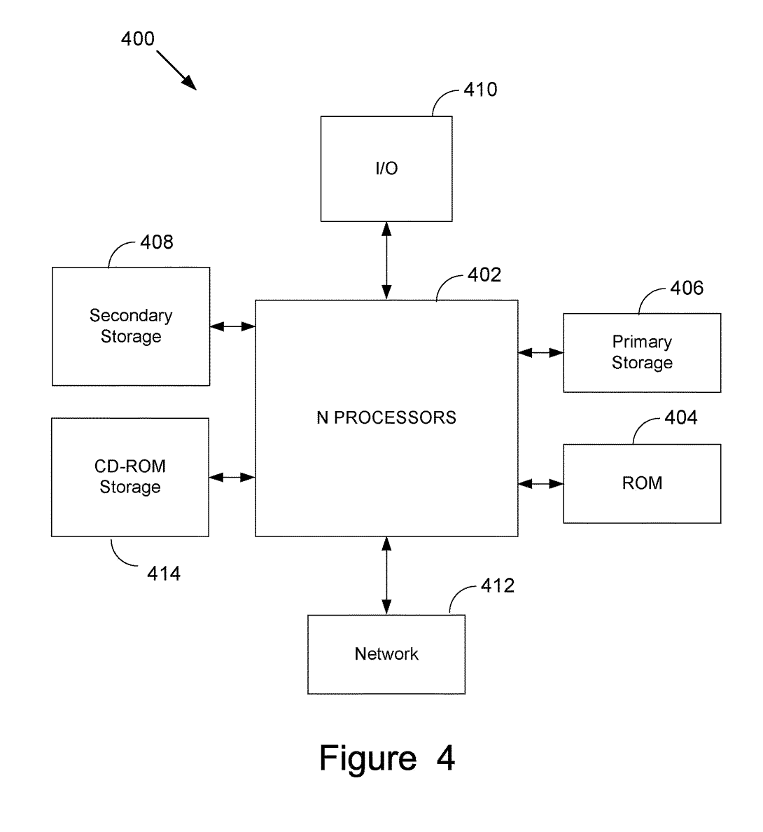

FIG. 4 illustrates a typical computer system that, when appropriately configured or designed, can serve as a computer system in which the invention may be embodied. The computer system 400 includes any number of processors 402 (also referred to as central processing units, or CPUs) that are coupled to storage devices including primary storage 406 (typically a random access memory, or RAM), primary storage 404 (typically a read only memory, or ROM). CPU 402 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 404 acts to transfer data and instructions uni-directionally to the CPU and primary storage 406 is used typically to transfer data and instructions in a bi-directional manner. Both of these primary storage devices may include any suitable computer-readable media such as those described above. A mass storage device 408 may also be coupled bi-directionally to CPU 402 and provides additional data storage capacity and may include any of the computer-readable media described above. Mass storage device 408 may be used to store programs, data and the like and is typically a secondary storage medium such as a hard disk. It will be appreciated that the information retained within the mass storage device 408, may, in appropriate cases, be incorporated in standard fashion as part of primary storage 406 as virtual memory. A specific mass storage device such as a CD-ROM 414 may also pass data uni-directionally to the CPU.

CPU 402 may also be coupled to an interface 410 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 402 optionally may be coupled to an external device such as a database or a computer or telecommunications or internet network using an external connection as shown generally at 412, which may be implemented as a hardwired or wireless communications link using suitable conventional technologies. With such a connection, it is contemplated that the CPU might receive information from the network, or might output information to the network in the course of performing the method steps described in the teachings of the present invention.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, a telephone operator/call center can be placed overseas or outside of the jurisdiction of the U.S.A. A server may also be placed overseas to reduce overall cost. which may be perform supported functions outside of the jurisdiction of the USA while the remaining method steps and/or system components of the forgoing embodiments are typically required to be located/performed in the US for practical considerations.

Having fully described at least one embodiment of the present invention, other equivalent or alternative methods of providing a social networking website for sharing information concerning other individuals according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. A system comprising:
means for hosting a social networking site;
means for enabling users of the social networking site to submit documentation regarding a person having socially unacceptable behavior;
means for storing the documentation;
means for facilitating transmission of at least part of the documentation between the users, individuals and networks; and
means for enabling communication between the users.

2. The system as recited in claim 1, further comprising means for enabling access to the documentation for making informed decisions regarding the person.

3. The system as recited in claim 1, further comprising means for enabling reporting of at least part of the documentation to government authorities.

4. The system as recited in claim 1, further comprising means for rating strength of the documents.

5. The system as recited in claim 1, further comprising means for enabling rebuttal of the documentation.

6. The system as recited in claim 1, further comprising means for searching the documentation.

7. The system as recited in claim 1, further comprising means for enabling a user to introduce a friend to multiple users.

8. The system as recited in claim 1, further comprising means for generating location specific reports regarding persons having socially unacceptable behavior.

9. The system as recited in claim 1, further comprising means for enabling users to post responses to submitted documentation.

10. A method executed by one or more processors comprising:
steps for hosting a social networking site;
steps for enabling users of the social networking site to submit documentation regarding a person having socially unacceptable behavior;
steps for storing the documentation;
steps for facilitating transmission of at least part of the documentation between the users, individuals and networks; and
steps for enabling communication between the users.

11. The method as recited in claim 10, further comprising steps for enabling access to the documentation for making informed decisions regarding the person.

12. The method as recited in claim 10, further comprising steps for enabling reporting of at least part of the documentation to government authorities.

13. The method as recited in claim 10, further comprising steps for rating strength of the documents.

14. The method as recited in claim 10, further comprising steps for enabling rebuttal of the documentation.

15. The method as recited in claim 10, further comprising steps for searching the documentation.

16. The method as recited in claim 10, further comprising steps for enabling a user to introduce a friend to multiple users.

17. The method as recited in claim 10, further comprising steps for generating location specific reports regarding persons having socially unacceptable behavior.

18. The method as recited in claim 10, further comprising steps for enabling users to post responses to submitted documentation.

19. A method executed by one or more processors comprising the steps of:
hosting a social networking website for identifying persons having socially unacceptable behavior;
enabling users of the social networking site to anonymously submit documentation regarding a person having socially unacceptable behavior;
rating strength of the documents based on types of documents;
storing the documentation in a database;
generating location specific reports regarding persons having socially unacceptable behavior;
enabling access to the documentation for making informed decisions regarding the person;
facilitating transmission of at least part of the documentation between the users, individuals and networks;
enabling reporting of at least part of the documentation to government authorities;
enabling rebuttal of the documentation;
enabling users to post responses to submitted documentation for viewing by all users;
enabling communication between the users; and
enabling a user to introduce a friend to multiple users.

20. The method as recited in claim 19, further comprising the step enabling outside users to search the database.
